(19) United States
(12) Patent Application Publication
(10) Pub. No.: US 2026/0185630 A1
(43) Pub. Date: Jul. 2, 2026

(54) NORMALLY-OPEN SOLENOID VALVES AND MASS FLOW CONTROLLERS HAVING NORMALLY-OPEN SOLENOID VALVES

(71) Applicant: Illinois Tool Works Inc., Glenview, IL (US)

(72) Inventors: Daniel T. Mudd, Freemont, CA (US); Andrew J. Staudt, Freemont, CA (US)

(21) Appl. No.: 19/434,529

(22) Filed: Dec. 29, 2025

Related U.S. Application Data
(60) Provisional application No. 63/739,963, filed on Dec. 30, 2024.

(51) Int. Cl. F16K 31/08; G05D 7/06

(52) U.S. Cl. CPC F16K 31/084; G05D 7/0635

(57) ABSTRACT

Disclosed example normally-open proportional valves include: a body comprising an inlet, an outlet, and an interior volume; a poppet configured to move within the interior volume between a seated position in which the poppet blocks gas flow between the inlet and the outlet, a fully opened position in which gas is permitted to flow between the inlet and the outlet, and positions between the seated position and the fully opened position; a biasing element configured to bias the poppet toward the seated position; a solenoid having a coil and a core; a permanent magnet positioned to bias the poppet away from the seated position; and control circuitry configured to selectively control the solenoid to control a net force of the permanent magnet and the solenoid on the poppet to control a position of the poppet.

### RELATED APPLICATIONS

The present application claims the benefit of U.S. Provisional Patent Application Ser. No. 63/739,963, filed Dec. 30, 2024, entitled “NORMALLY-OPEN SOLENOID VALVES AND MASS FLOW CONTROLLERS HAVING NORMALLY-OPEN SOLENOID VALVES.” The entirety of U.S. Provisional Patent Application Ser. No. 63/739,963 is expressly incorporated herein by reference.

### FIELD OF THE DISCLOSURE

This disclosure relates to mass flow control and, more particularly, to normally-open solenoid valves and mass flow controllers having normally-open solenoid valves.

### BACKGROUND

A mass flow controller (MFC) is a device for controlling the flow of fluid through a flow path based on a desired flow rate and real-time feedback measurements of measured temperature, pressure, and flow rate of the fluid. In order to control this process and maintain the desired flow rate the mass flow controller electro-mechanically controls the opening and closing of a valve to achieve the desired flow rates according to the feedback measurements. A valve can be constructed to default to be either “normally-closed” (blocking flow) or “normally-open” (allowing flow) in the event of a loss of power or control to the valve.

### SUMMARY

Normally-open solenoid valves and mass flow controllers having normally-open solenoid valves are disclosed, substantially as illustrated by and described in connection with at least one of the figures.

### BRIEF DESCRIPTION OF THE DRAWINGS

The benefits and advantages of the present disclosure will become more readily apparent to those of ordinary skill in the relevant art after reviewing the following detailed description and accompanying drawings, wherein:

FIG. 1 is a block diagram of an example mass flow controller, in accordance with aspects of this disclosure.

FIG. 2 is an example normally-open proportional valve that may be used to implement the valve in the mass flow controller of FIG. 1.

FIG. 3 is a more detailed view of the example valve of FIG. 2, including magnetic field lines to control a net magnetic force.

FIG. 4 is a flowchart representative of example machine readable instructions which may be executed by the control circuitry of FIG. 1 to control a mass flow controller having a normally-open solenoid valve.

FIG. 5 is a block diagram of an example computing device that may be used to implement the valve control circuitry of FIG. 1.

The figures are not necessarily to scale. Where appropriate, similar or identical reference numbers are used to refer to similar or identical components.

### DETAILED DESCRIPTION

Some conventional valves for mass flow controllers use piezo-based actuators to actuate the valve. In a piezo-based actuator, a piezo stack lengthens in response to being subjected to an electric field, and contracts in response to a reduction or removal of the electric field. While piezo-based devices have benefits, piezo-based valves are significantly more expensive than some other types of actuators, such as solenoid actuators and have limited stroke. For example, a two-inch-tall piezo-based actuator is limited to approximately 0.002 inches of stroke. Other conventional valves use solenoid-based actuators, which are typically constructed as normally-closed valves. While some conventional valves have been constructed as normally-open solenoid-based valves, these conventional valves involve complex and costly circuitry to operate the normally-open solenoid-based valve.

Disclosed example normally-open solenoid valves, and mass flow controllers having normally-open solenoid valves, are constructed to be less expensive than conventional normally-open solenoid-based valves and piezo-based valves, while enabling accurate control of gas flow through the valve. In some disclosed examples, a valve includes a poppet within a valve body, which is movable between a fully open position and a fully closed position. The poppet is coupled to a biasing element, such as a radial spring, that biases the poppet toward the fully closed position. Example valves further include a solenoid actuator and a permanent magnet. The permanent magnet applies a magnetic force on the poppet that biases the poppet away from the closed position (e.g., toward the fully open position). In disclosed examples, the net force of the permanent magnet and the biasing element on the poppet is zero when the poppet is in an opened position, such that the valve is normally-open (e.g., when there is solenoid is de-energized).

In disclosed examples, the solenoid actuator may be actuated to modify the magnetic field of the permanent magnet, which may decrease the net force of the permanent magnet and the solenoid on the poppet and allow the biasing element to move the poppet toward the closed position. By controlling the current to the solenoid coil and, thus, the magnetic field generated by the solenoid actuator, disclosed example valves control the position of the poppet and the flow of gas through the valve. In some examples, a gap between the permanent magnet and the poppet, and/or a gap between the solenoid (e.g., a core of the solenoid, the coil of the solenoid) are constructed to obtain the desired balance between the magnetic fields of the coil and the permanent magnet, and the force applied by the biasing element.

According to some aspects of this disclosure, example normally-open proportional valves include: a body comprising an inlet, an outlet, and an interior volume; a poppet configured to move within the interior volume between a seated position in which the poppet blocks gas flow between the inlet and the outlet, a fully opened position in which gas is permitted to flow between the inlet and the outlet, and positions between the seated position and the fully opened position; a biasing element configured to bias the poppet toward the seated position; a solenoid having a coil and a core; a permanent magnet positioned to bias the poppet away from the seated position; and control circuitry configured to selectively control the solenoid to control a net force of the permanent magnet and the solenoid on the poppet to control a position of the poppet.

In some example normally-open proportional valves, the core of the solenoid is configured such that a gap between a face of the core and the poppet is greater than a gap between the permanent magnet and the poppet. In some example normally-open proportional valves, the core includes a recess in the face of the core, and at least a portion of the permanent magnet is positioned within the recess.

In some example normally-open proportional valves, the net force of the permanent magnet and the coil on the poppet is proportional to Ampere-turns in the coil. In some example normally-open proportional valves, the control circuitry is configured to increase a current in the coil to reduce the net force of the permanent magnet and the coil on the poppet. In some example normally-open proportional valves, the force of the permanent magnet on the poppet while the current in the coil is zero is greater than a biasing force of the biasing element on the poppet in the seated position.

In some example normally-open proportional valves, the net force of the permanent magnet and the coil on the poppet is inversely related to Ampere-turns in the coil. In some example normally-open proportional valves, the control circuitry is configured to control a current through the coil based on a desired gas flow rate through the body. In some example normally-open proportional valves, the control circuitry is configured to: control a current to flow through the coil in a first direction to increase the net force of the permanent magnet and the coil on the poppet to move the poppet further away from the closed position; and control the current to flow through the coil in a second direction to decrease the net force of the permanent magnet and the coil on the poppet to move the poppet toward the closed position.

According to some aspects of this disclosure, example mass flow controllers include: a flow sensor configured to sense a mass flow of gas through a flow path; and a normally-open, proportional flow controller configured to control flow of the gas through the flow path, the flow controller including: a body comprising an inlet, an outlet, and an interior volume; a poppet configured to move within the interior volume between a seated position in which the poppet blocks gas flow between the inlet and the outlet, a fully opened position in which gas is permitted to flow between the inlet and the outlet, and positions between the seated position and the fully opened position; a biasing element configured to bias the poppet toward the seated position; a solenoid having a coil and a core; a permanent magnet positioned to bias the poppet away from the seated position; and control circuitry configured to selectively control the solenoid to control a net force of the permanent magnet and the solenoid on the poppet to control a position of the poppet.

In some example mass flow controllers, the core of the solenoid is configured such that a gap between a face of the core and the poppet is greater than a gap between the permanent magnet and the poppet. In some example mass flow controllers, the core includes a recess in the face of the core, and at least second a portion of the permanent magnet is positioned within the recess. In some example mass flow controllers, the net force of the permanent magnet and the coil on the poppet is inversely related to Ampere-turns in the coil.

In some example mass flow controllers, the control circuitry is configured to increase a current in the coil to reduce the net force of the permanent magnet and the coil on the poppet. In some example mass flow controllers, the force of the permanent magnet on the poppet while the current in the coil is zero is greater than a biasing force of the biasing element on the poppet in the seated position. In some example mass flow controllers, the net force of the permanent magnet and the coil on the poppet is inversely proportional to Ampere-turns in the coil.

In some example mass flow controllers, the control circuitry is configured to control a current through the coil based on a desired gas flow rate through the body. In some example mass flow controllers, the control circuitry is configured to: control a current to flow through the coil in a first direction to increase the net force of the permanent magnet and the coil on the poppet to move the poppet further away from the closed position; and control the current to flow through the coil in a second direction to decrease the net force of the permanent magnet and the coil on the poppet to move the poppet toward the closed position.

According to some aspects of this disclosure, example methods to control gas flow involve: reducing a gas flow through a flow controller by controlling a solenoid of the flow controller to reduce a net force applied by a permanent magnet and the solenoid on a poppet within an internal volume of a valve body of the flow controller; and increasing a gas flow through the flow controller by reducing a current in the solenoid of the flow controller.

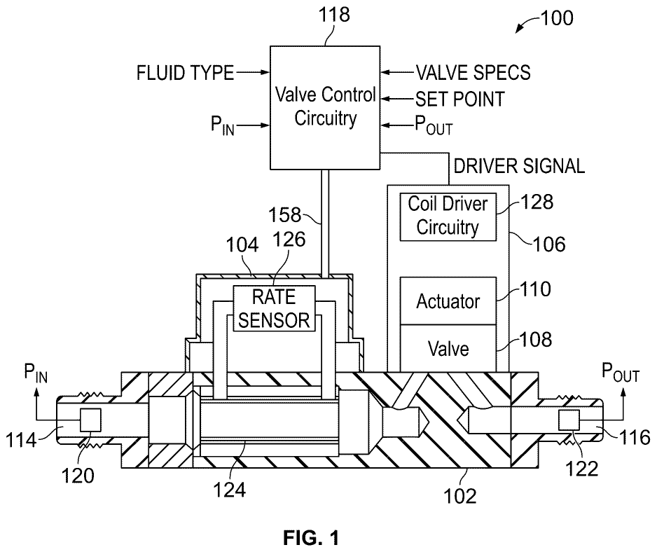

FIG. 1 is a block diagram of an example mass flow controller (MFC) 100. The example MFC 100 includes a base 102, a mass flow meter 104, and a valve assembly 106. The mass flow meter 104 and the valve assembly 106 are mounted on the base 102. The base 102 may further include a fluid inlet 114 and a fluid outlet 116. The MFC controls the flow of gas from the fluid inlet 114 to the fluid outlet 116. While the example MFC 100 is illustrated as having the mass flow meter 104 upstream of the valve assembly 106 (e.g., the mass flow meter 104 is positioned between the valve assembly 106 and the valve inlet 114).

The example valve assembly 106 includes a valve 108 and actuator 110. The valve 108 is actuated by the actuator 110 to control a flow of the gas from the fluid inlet 114 to the fluid outlet 116. As disclosed in more detail below, the example valve assembly 106 may be a normally-open valve having a solenoid actuator.

The MFC 100 includes an inlet pressure transducer 120 configured to measure a pressure at an upstream position (e.g., at the valve inlet 114) and an outlet pressure transducer 122 configured to measure a pressure at a downstream position (e.g., at the valve outlet 116).

The example MFC 100 further includes valve control circuitry 118 communicatively coupled to the mass flow meter 104 and the valve assembly 106. The example valve control circuitry 118 receives pressure signals from the inlet and outlet pressure transducers 120, 122.

The valve control circuitry 118 includes a processor, which may be a general-purpose central processing unit (CPU). In some examples, the valve control circuitry 118 may be implemented using, or include, one or more specialized processing units, such as FPGA, RISC processors with an ARM core, graphic processing units, digital signal processors, and/or system-on-chips (SoC). The valve control circuitry 118 executes machine-readable instructions that may be stored locally at the valve control circuitry 118 (e.g., in an included cache or SoC), in a random access memory (or other volatile memory), in a read-only memory (or other non-volatile memory such as FLASH memory), and/or in a mass storage device. Example mass storage devices include a hard drive, a solid-state storage drive, a hybrid drive, a RAID array, and/or any other mass data storage device.

The example mass flow meter 104 may be a thermal-type flow meter, a pressure-type flow meter, a Coriolis-type flow meter, and/or any other type of flow meter. The example mass flow meter 104 of FIG. 1 includes a bypass channel 124, through which a portion of the fluid flows and another channel with a flow rate sensor 126 through which a smaller portion of the fluid flows.

In operation, as fluid flows past the pressure transducers 120 and 122 and the flow rate sensor 126, the flow rate sensor 126 and the pressure transducers 120, 122 measure and provide real-time pressure data, flow rate data, and/or temperature data to the valve control circuitry 118. The flow rate of the fluid can be sensitive and a number of operating conditions including fluid type, inlet and outlet pressure, temperature, flow rate set point value, and valve operating characteristics all can affect the fluid flow rate, i.e. cause a deviation in the rate from a desired set rate. The valve control circuitry 118 controls operation of the valve assembly 106 (e.g., in real-time) by providing an error-correcting drive signal to the valve actuator 110 to adjust the position of the valve 108. The change in the position of the valve 108 controls the flow rate. The valve control circuitry 118 may use factors such as the fluid type, inlet and outlet pressure transducer readings, a flow rate set point value, valve specifications, and/or valve calibration data to control the operation of the valve 108. In some examples, the valve control circuitry 118 uses closed-loop control, such as proportional control, integral control, proportional-integral (PI) control, derivative control, proportional-derivative (PD) control, integral-derivative (ID) control, proportional-integral-derivative (PID) control, and/or any other types of closed-loop or feedback-based control, to control the flow of fluid in the MFC 100.

In some examples, the valve control circuitry 118 includes an operator interface (e.g., one or more operator input device(s) and/or operator output device(s)) and/or a communication interface (e.g., wired and/or wireless communications circuitry) to receive commands, configuration variables, setpoints (e.g., a flow rate setpoint), gas characteristics, and/or other data. The operator interface and/or the communication interface may further output data for viewing by an operator and/or to one or more external devices.

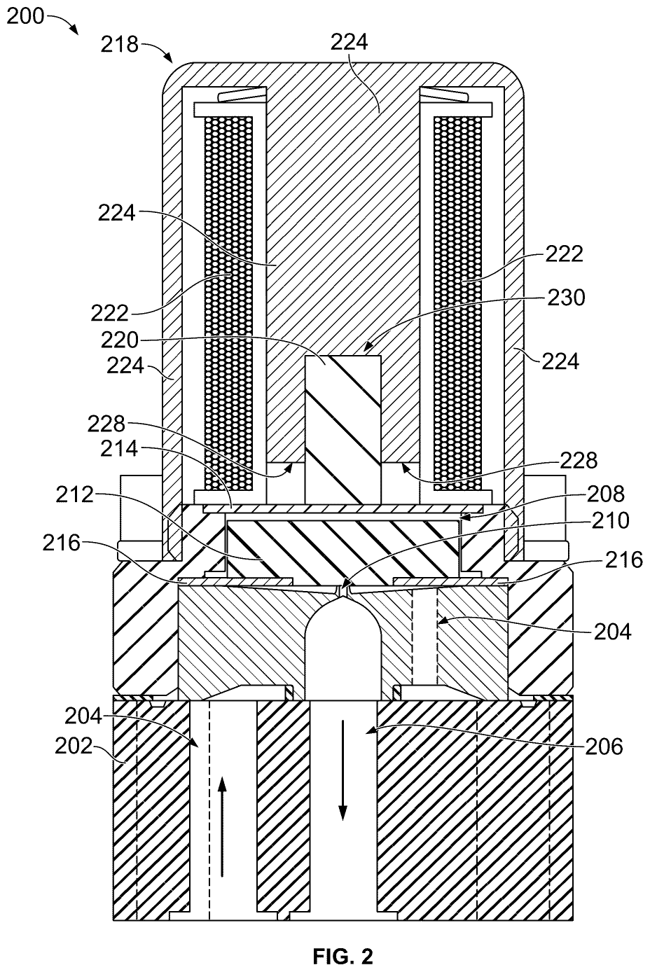

FIG. 2 is an example normally-open proportional valve 200 that may be used to implement the valve 108 in the MFC 100 of FIG. 1. The example valve 200 includes a valve body 202 which has a fluid inlet 204 and a fluid outlet 206. The valve body 202 further defines an interior volume 208, which communicatively couples the fluid inlet 204 to the fluid outlet 206. The interface between the interior volume 208 may be defined by a valve seat 210.

The valve 200 further includes a poppet 212 within the interior volume 208. The poppet 212 is configured to move within the interior volume 208 between a closed position (e.g., a seated position) and a fully opened position, including positions between the closed position and the fully opened position. In the closed position, the poppet 212 abuts the valve seat 210 to stop flow of the gas from fluid inlet 204 to the fluid outlet 206. Conversely, in the fully opened position, the poppet 212 is moved away from the valve seat 210 to allow full flow of gas from the fluid inlet 204 to the fluid outlet 206. In some examples, the range of movement of the poppet 212 is defined by the interior volume 208. A diaphragm 214 may be positioned opposite the valve seat 210 to seal against escape of gas other than through the fluid outlet 206, and/or to seal non-wetted surfaces from being exposed to potentially corrosive gases.

The example valve 200 further includes a biasing element 216 coupled to the poppet 212 to bias the poppet 212 toward the closed position. The example biasing element 216 is a radial spring, which increases the force applied to the poppet 212 toward the closed position as the poppet 212 moves farther from the closed position.

The valve 200 further includes a solenoid 218 and a permanent magnet 220. The solenoid 218 includes a coil 222 and a core 224, and generates a magnetic field based on the Ampere-turns in the coil 222, as well as the structure of the core 224. The permanent magnet 220 generates a magnetic field, and is positioned to bias the poppet 212 away from the closed position. In this manner, the permanent magnet 220 provides a force opposed to the force of the biasing element 216.

The valve control circuitry 118 may selectively control the solenoid 218 to control a net force of the permanent magnet 220 and the solenoid 218 on the poppet 212 to control a position of the poppet 212. For example, the valve control circuitry 118 may control the current through the coil 222 to create a magnetic field. The strength of the coil-generated magnetic field and can be controlled by the amount of current provided to the coil 222 (e.g., by varying the voltage applied to the terminals of the coil 222).

In the example of FIG. 2, the coil 222 is wound in a direction such that the polarity of the magnetic field generated by the coil 222 is opposed to the direction of the magnetic field generated by the permanent magnet 220. As the valve control circuitry 118 increases the current in the coil 222, the magnetic field increasingly influences the magnetic field from the permanent magnet 220 to result in a combined or net magnetic field that has a reduced net force on the poppet 212 compared to the magnetic force from the permanent magnet 220. The net magnetic field applied by the combined magnetic fields of the coil 222 and the permanent magnet 220 allows the biasing element 216 to pull the poppet 212 further toward the closed position. The coil 222, the core 224, and the permanent magnet 220 may be constructed and/or arranged to provide the desired net magnetic fields that apply a net force to the poppet 212 in relation to the current in the coil 222.

At a sufficiently high current (referred to herein as a correlation threshold current), the coil 222 generates a magnetic field that overcomes the opposing magnetic field of the permanent magnet 220. As a result, the net magnetic field begins to pull the poppet 212 further toward the fully open position in response to further increases in current. Between zero current and the correlation threshold current, the net force of the permanent magnet 220 and the coil 222 on the poppet 212 is inversely related to the Ampere-turns in the coil 222 (or the current, when the number of turns in the coil 222 is fixed). In some examples, the valve control circuitry 118 limits the voltage and/or current that can be applied to the coil 222 such that the current in the coil 222 does not exceed the correlation threshold current.

In some examples, referring to FIG. 1, the valve control circuitry 118 controls the current through the 222 by controlling coil driver circuitry 128 to conduct current through the coil 222. The coil driver circuitry 128 may include any type of power conversion circuitry or power supply circuitry to convert input power to output a coil current, and output the coil current to the coil 222. For example, the coil driver circuitry 128 may include AC-DC conversion circuitry and/or DC-DC conversion circuitry, such as switched-mode power supplies, step-up converters, step-down converters, forward converters, flyback converters, and/or any other type of conversion circuitry. In some examples, all or a portion of the coil driver circuitry 128 may be integrated into the valve control circuitry 118, such as by including the coil driver circuitry 128 in a same semiconductor package as the valve control circuitry 118, and/or may be implemented on a same printed circuit board as the valve control circuitry 118.

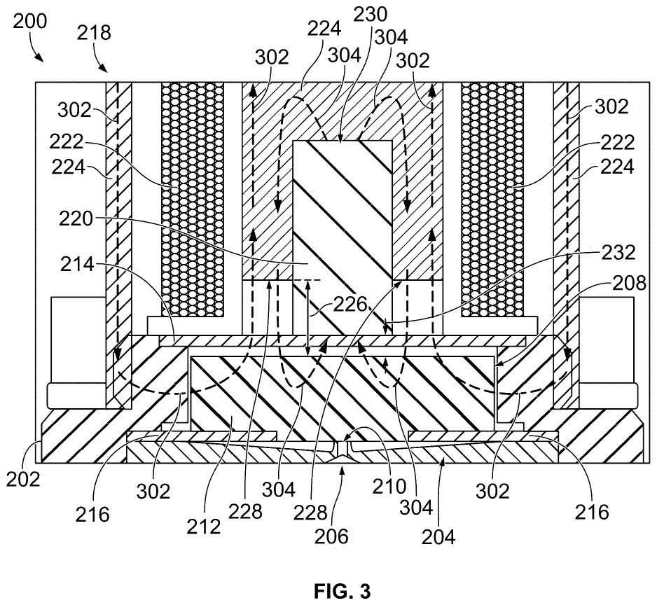

FIG. 3 is a more detailed view of the example valve 200 of FIG. 2, including magnetic field lines to control a net magnetic force. In the example of FIGS. 2 and 3, the core 224 of the solenoid 218 is configured such that a gap 226 between a face 228 of the core 224 and the poppet 212 is greater than a gap 232 between a face of the permanent magnet 220 and the poppet 212. The face 228 of the core 224 is receded from the poppet 212 to increase the gap 226, which limits and/or reduces the attractive force on the poppet 212 from a magnetic field 302 generated by the coil 222. The size of the gap 226 is also increased to increase the influence of the magnetic field 302 on counter-acting a magnetic field 304 of the permanent magnet 220 and reduce the force directly applied to the poppet 212 by the solenoid 218.

Similarly, the size of the gap 232, the size of the permanent magnet 220, and the material of the permanent magnet 220 may be selected to balance a force applied to the poppet 212 by the permanent magnet 220 with a biasing force applied by the biasing element 216. For example, the size of the gap 232, the size of the permanent magnet 220, the material of the permanent magnet 220, and the spring constant of the biasing element 216 may all be selected to position the poppet 212 at a desired equilibrium position at which the force from the permanent magnet 220 balances the force applied by the biasing element 216 (e.g., while the solenoid 218 is de-energized). The desired equilibrium position may be a fully open position or a partially open position.

In the example of FIGS. 2 and 3, the core 224 has a recess 230, and a portion of the permanent magnet 220 is positioned within the recess 230. However, in other examples, the permanent magnet 220 may be positioned on a face of the core 224 and/or at another desired location, and the recess 230 may be omitted.

In operation, the example valve control circuitry 118 controls the current flowing through the coil 222 to control a net force on the poppet 212 from the magnetic fields 302, 304 of the coil 222 and the permanent magnet 220. By controlling a net force from the combined magnetic fields, the valve control circuitry 118 pulls the poppet 212 toward the fully open position (e.g., away from the closed position) to increase gas flow (up to an upper flow limit at a fully opened position), and reduces the force to allow the biasing element to pull the poppet 212 toward the closed position to reduce or stop gas flow. For example, by increasing the current through the coil 222, the valve control circuitry 118 increases the magnetic field 302, which reduces the effect of the magnetic field 304 on the poppet 212. Conversely, by decreases the current through the coil 222, the valve control circuitry 118 decreases the magnetic field 302, which restores the effect of the magnetic field 304 on the poppet 212. Accordingly, the valve control circuitry 118 may control a current through the coil 222 based on a desired gas flow rate through the base 102 (e.g., as measured by the mass flow meter 104 of FIG. 1).

In some examples, the coil driver circuitry 128 is configured to selectively reverse the polarity of the voltage applied to the coil 222, causing the current direction to be reversed. As a result of reversing the current, the example coil 222 changes the direction of the magnetic field 302. In examples in which the equilibrium position of the permanent magnet 220 and the biasing element 216 is between the fully open position and the closed position, the example coil driver circuitry 128 may be controlled to reverse of the current to control whether the magnetic field 302 generated by the coil 222 is additive or interfering with the magnetic field 304 generated by the permanent magnet 220, thereby causing the current through the coil 222 to increase or decrease the net force of the permanent magnet 220 and the coil 222 on the poppet 212 toward the fully opened position.

In some examples, the diaphragm 214 is omitted and the permanent magnet 220 and the recess 230 are wetted surfaces (e.g., exposed to the gas). If operating on corrosive gases, the permanent magnet 220 and the recess 230 may be provided with a corrosion protection coating or otherwise constructed to be corrosion resistant. Additionally or alternatively, the coil 222 and/or the core 224 may be protected by a thin tube for insulation from a corrosive gas.

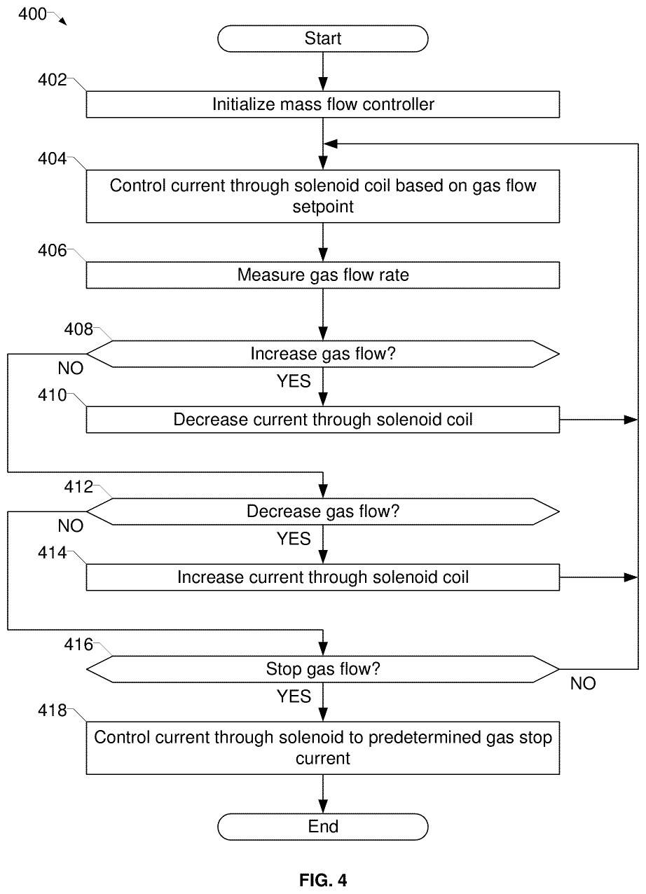

FIG. 4 is a flowchart representative of example machine readable instructions 400 which may be executed by the valve control circuitry 118 of FIG. 1 to control a mass flow controller (e.g., the mass flow controller 100 of FIG. 1) having a normally-open solenoid valve (e.g., the valve 200 of FIG. 2).

At block 402, the example valve control circuitry 118 initializes the mass flow controller 100. For example, the valve control circuitry 118 may load stored valve characteristics and/or setpoints, conduct calibrations, and/or otherwise prepare the mass flow controller 100 for flow control.

At block 404, the valve control circuitry 118 controls a current through the coil 222 of the solenoid 218 based on a gas flow setpoint. For example, the valve control circuitry 118 may apply a voltage to cause a current to flow through the coil 222 based on the valve characteristics and feedback from the mass flow meter 104. The current in the coil 222 increases or decreases a net force on the poppet 212, to cause the poppet 212 to move toward the closed position or the fully open position, while the biasing element 216 applies a force that also varies based on the position of the poppet 212. At block 406, the valve control circuitry 118 measures a gas flow rate via the mass flow meter 104.

At block 408, the valve control circuitry 118 determines whether to increase the gas flow. For example, the valve control circuitry 118 may determine that gas flow should be increased based on a comparison between the measured gas flow (block 406) and a gas flow setpoint. If the gas flow is to be increased (block 408), at block 410 the valve control circuitry 118 decreases a current through the coil 222. The reduction in current also reduces the magnetic field 302 generated by the coil 222 (and also reduces the interference with the magnetic field 304), and increases a net force of the permanent magnet 220 and the solenoid 218 on the poppet 212. The increased net force on the poppet 212 causes the poppet 212 to move toward the fully open position (by an amount based on the change in the net force), and increases the flow of gas through the valve 200. Control then returns to block 404 to continue controlling the current through the solenoid coil 222.

If the gas flow is not to be increased (block 408), at block 412 the valve control circuitry 118 determines whether to decrease the gas flow. For example, the valve control circuitry 118 may determine that gas flow should be decreased based on a comparison between the measured gas flow (block 406) and the gas flow setpoint. If the gas flow is to be decreased (block 412), at block 414 the valve control circuitry 118 increases a current through the coil 222. The increase in current also increases the magnetic field 302 generated by the coil 222 (and also reduces the effect of the magnetic field 304 on the poppet 212), and reduces a net force of the permanent magnet 220 and the solenoid 218 on the poppet 212. The reduced net force on the poppet 212 permits the biasing element 216 to pull the poppet 212 toward the closed position (by an amount based on the change in the net force), and decreases the flow of gas through the valve 200. Control then returns to block 404 to continue controlling the current through the solenoid coil 222.

If the gas flow is also not to be increased (block 412), at block 416 the valve control circuitry 118 determines whether to stop the gas flow. If the gas flow is not to be stopped (block 416), control returns to block 404 to continue controlling the current through the solenoid coil 222. If the gas flow is to be stopped (block 416), at block 418 the valve control circuitry 118 controls the current through the coil 222 to be a predetermined gas stop current. The predetermined gas stop current increases the magnetic field 302 generated by the coil 222 (and also reduces the effect of the magnetic field 304 on the poppet 212), and reduces a net force of the permanent magnet 220 and the solenoid 218 on the poppet 212 sufficiently for the biasing element 216 to pull the poppet 212 into the closed position (e.g., seated on the valve seat 210). The example instructions 400 may then end. In some examples, blocks 404-418 may be iterated while the valve 200 is in operation.

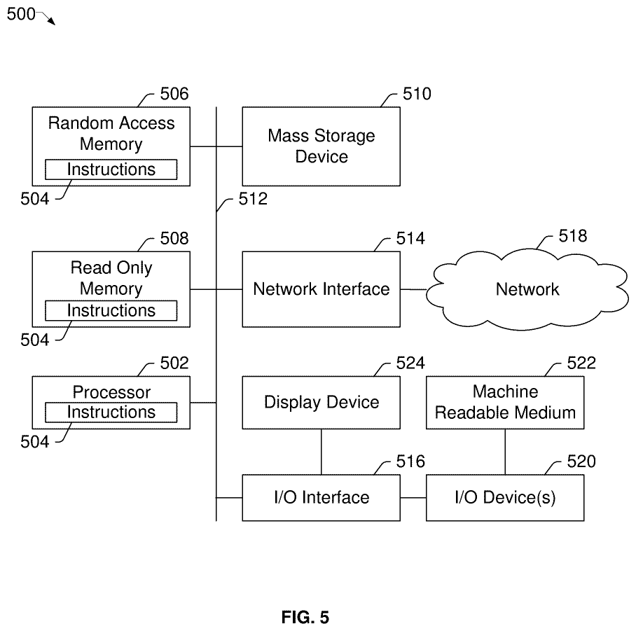

FIG. 5 is a block diagram of an example computing device 500 that may be used to implement the valve control circuitry 118 of FIG. 1. The example computing device 500 may be a general-purpose computer, a laptop computer, a tablet computer, a mobile device, a server, an all-in-one computer, and/or any other type of computing device. The computing device 500 of FIG. 5 includes a processor 502, which may be a general-purpose central processing unit (CPU). In some examples, the processor 502 may include one or more specialized processing units, such as FPGA, RISC processors with an ARM core, graphic processing units, digital signal processors, and/or system-on-chips (SoC). The processor 502 executes machine-readable instructions 504 that may be stored locally at the processor (e.g., in an included cache or SoC), in a random access memory 506 (or other volatile memory), in a read-only memory 508 (or other non-volatile memory such as FLASH memory), and/or in a mass storage device 510. The example mass storage device 510 may be a hard drive, a solid-state storage drive, a hybrid drive, a RAID array, and/or any other mass data storage device. A bus 512 enables communications between the processor 502, the RAM 506, the ROM 508, the mass storage device 510, a network interface 514, and/or an input/output interface 516.

An example network interface 514 includes hardware, firmware, and/or software to connect the computing device 500 to a communications network 518 such as the Internet. For example, the network interface 514 may include IEEE 802.X-compliant wireless and/or wired communications hardware for transmitting and/or receiving communications.

An example I/O interface 516 of FIG. 5 includes hardware, firmware, and/or software to connect one or more input/output devices 520 to the processor 502 for providing input to the processor 502 and/or providing output from the processor 502. For example, the I/O interface 516 may include a graphics-processing unit for interfacing with a display device, a universal serial bus port for interfacing with one or more USB-compliant devices, a FireWire, a field bus, and/or any other type of interface. The example computing device 500 may include a display device 524 (e.g., an LCD screen) coupled to the I/O interface 516. Other example I/O device(s) 520 may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device.

The computing device 500 may access a non-transitory machine-readable medium 522 via the I/O interface 516 and/or the I/O device(s) 520. Examples of the machine-readable medium 522 of FIG. 5 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine-readable media.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer-readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine-readable storage media and to exclude propagating signals.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A normally-open proportional valve, comprising:
a body comprising an inlet, an outlet, and an interior volume;
a poppet configured to move within the interior volume between a seated position in which the poppet blocks gas flow between the inlet and the outlet, a fully opened position in which gas is permitted to flow between the inlet and the outlet, and positions between the seated position and the fully opened position;
a biasing element configured to bias the poppet toward the seated position;
a solenoid having a coil and a core;
a permanent magnet positioned to bias the poppet away from the seated position; and
control circuitry configured to selectively control the solenoid to control a net force of the permanent magnet and the solenoid on the poppet to control a position of the poppet.

2. The normally-open proportional valve as defined in claim 1, wherein the core of the solenoid is configured such that a gap between a face of the core and the poppet is greater than a gap between the permanent magnet and the poppet.

3. The normally-open proportional valve as defined in claim 2, wherein the core comprises a recess in the face of the core, and at least a portion of the permanent magnet is positioned within the recess.

4. The normally-open proportional valve as defined in claim 1, wherein the net force of the permanent magnet and the coil on the poppet is proportional to Ampere-turns in the coil.

5. The normally-open proportional valve as defined in claim 1, wherein the control circuitry is configured to increase a current in the coil to reduce the net force of the permanent magnet and the coil on the poppet.

6. The normally-open proportional valve as defined in claim 5, wherein the force of the permanent magnet on the poppet while the current in the coil is zero is greater than a biasing force of the biasing element on the poppet in the seated position.

7. The normally-open proportional valve as defined in claim 1, wherein the net force of the permanent magnet and the coil on the poppet is inversely related to Ampere-turns in the coil.

8. The normally-open proportional valve as defined in claim 1, wherein the control circuitry is configured to control a current through the coil based on a desired gas flow rate through the body.

9. The normally-open proportional valve as defined in claim 1, wherein the control circuitry is configured to:
control a current to flow through the coil in a first direction to increase the net force of the permanent magnet and the coil on the poppet to move the poppet further away from the closed position; and
control the current to flow through the coil in a second direction to decrease the net force of the permanent magnet and the coil on the poppet to move the poppet toward the closed position.

10. A mass flow controller, comprising:
a flow sensor configured to sense a mass flow of gas through a flow path; and
a normally-open, proportional flow controller configured to control flow of the gas through the flow path, the flow controller comprising:
a body comprising an inlet, an outlet, and an interior volume;
a poppet configured to move within the interior volume between a seated position in which the poppet blocks gas flow between the inlet and the outlet, a fully opened position in which gas is permitted to flow between the inlet and the outlet, and positions between the seated position and the fully opened position;
a biasing element configured to bias the poppet toward the seated position;
a solenoid having a coil and a core;
a permanent magnet positioned to bias the poppet away from the seated position; and
control circuitry configured to selectively control the solenoid to control a net force of the permanent magnet and the solenoid on the poppet to control a position of the poppet.

11. The mass flow controller as defined in claim 10, wherein the core of the solenoid is configured such that a gap between a face of the core and the poppet is greater than a gap between the permanent magnet and the poppet.

12. The mass flow controller as defined in claim 11, wherein the core comprises a recess in the face of the core, and at least second a portion of the permanent magnet is positioned within the recess.

13. The mass flow controller as defined in claim 11, wherein the net force of the permanent magnet and the coil on the poppet is inversely related to Ampere-turns in the coil.

14. The mass flow controller as defined in claim 10, wherein the control circuitry is configured to increase a current in the coil to reduce the net force of the permanent magnet and the coil on the poppet.

15. The mass flow controller as defined in claim 14, wherein the force of the permanent magnet on the poppet while the current in the coil is zero is greater than a biasing force of the biasing element on the poppet in the seated position.

16. The mass flow controller as defined in claim 10, wherein the net force of the permanent magnet and the coil on the poppet is inversely proportional to Ampere-turns in the coil.

17. The mass flow controller as defined in claim 10, wherein the control circuitry is configured to control a current through the coil based on a desired gas flow rate through the body.

18. The mass flow controller as defined in claim 10, wherein the control circuitry is configured to:
control a current to flow through the coil in a first direction to increase the net force of the permanent magnet and the coil on the poppet to move the poppet further away from the closed position; and
control the current to flow through the coil in a second direction to decrease the net force of the permanent magnet and the coil on the poppet to move the poppet toward the closed position.

19. A method to control gas flow, comprising:
reducing a gas flow through a flow controller by controlling a solenoid of the flow controller to reduce a net force applied by a permanent magnet and the solenoid on a poppet within an internal volume of a valve body of the flow controller; and
increasing a gas flow through the flow controller by reducing a current in the solenoid of the flow controller.
